(19) United States
(12) Patent Application Publication
(10) Pub. No.: US 2014/0042086 A1
(43) Pub. Date: Feb. 13, 2014

(54) METHOD FOR IMPROVING A WASTEWATER PURIFICATION PROCESS

(71) Applicants: Dan Weber, Northville, MI (US); Nick Lionas, Northville, MI (US); Ron Kress, Northville, MI (US)

(72) Inventors: Dan Weber, Northville, MI (US); Nick Lionas, Northville, MI (US); Ron Kress, Northville, MI (US)

(21) Appl. No.: 13/961,541

(22) Filed: Aug. 7, 2013

Related U.S. Application Data
(60) Provisional application No. 61/680,574, filed on Aug. 7, 2012.

(51) Int. Cl. C02F 1/68; C02F 3/30

(52) U.S. Cl. CPC C02F 1/68; C02F 3/301; C02F 3/302
USPC 210/605; 210/749; 210/757

(57) ABSTRACT

The present invention relates to a method for improving a wastewater purification process for a wastewater stream containing organic materials, raw sludge, a plurality of mercaptans, grit and grease wherein the raw sludge is thickened in the wastewater stream by injecting polymers. The method includes a step of injecting an additive agent prior to thickening the raw sludge to reduce odor produced by the organic materials and the mercaptans.

### CROSS REFERENCE TO RELATED APPLICATION

This application claims priority to U.S. Provisional Patent Application Ser. No. 61/680,574, filed on Aug. 7, 2012, and entitled “A Method for Improving a Wastewater Purification Process”, which is hereby incorporated by reference.

### TECHNICAL FIELD

The present disclosure relates to a method for improving a wastewater purification process.

### BACKGROUND OF THE DISCLOSURE

As the density of urban populations increase, so does the amount of sewage that is generated. Sewage is known to be generated by residential, institutional, commercial and industrial establishments. Sewage includes household waste liquid from toilets, baths, showers, kitchens, sinks and the like and is disposed of via sewers. In many areas, sewage also includes liquid waste from industry and commerce. As water is one of the greatest needs of any community, the treatment of this wastewater to preserve good, quality water, is of paramount importance.

In general, the wastewater treatment process is similar to the natural process by which water is cleaned while moving through a river. Early on, towns and communities pumped raw sewage from homes, businesses and factories directly into rivers, streams, lakes and oceans. As human populations grew, this practice degraded the water quality to the point of posing serious health hazards. Increasing growth and development created a demand for clean water that exceeded the rate at which it could occur naturally in streams and rivers. At one point, many rivers and streams were so polluted that sewage posed a health risk. Changes in national policies, such as the Clean Water Act, created broad sweeping legislation that led to the construction of many wastewater treatment plants and a national focus to improve our national waters.

Accordingly, collection systems have been developed to transport the wastewater from homes, businesses and industry to wastewater treatment plants in order that it is subjected to a treatment process. Wastewater treatment today, in its various forms, still contains treatment processes that utilize soil and water microorganisms to convert the organic substances in wastewater into harmless materials.

Various wastewater purification processes are known in the prior art. An exemplary wastewater purification process is disclosed in U.S. Pat. No. 6,447,687, issued to Winn et al. on Sep. 10, 2002 which teaches a method for purifying a wastewater stream containing organic materials, raw sludge, a plurality of mercaptans, grit and grease. The method includes a step of thickening the raw sludge in the wastewater stream by injecting polymers. By injecting the polymers, the amount of sludge cakes produced in the wastewater purification process is increased. Accordingly, the amount of mercaptans and organic materials contained in the sludge cakes is also increased, which in turn can cause an increase in foul odor in the sludge cakes. Hence, it is also necessary to reduce the odor produced by the sludge cake.

### SUMMARY OF THE DISCLOSURE

The present disclosure provides a method for improving the wastewater treatment process by injecting an additive agent into the wastewater stream prior to injecting polymers into the wastewater stream for the purpose of thickening the raw sludge to reduce odor produced by the organic materials and the mercaptans.

The present disclosure improves the wastewater treatment process by decreasing the amount of sludge that needs to be disposed of and reducing the foul odor produced by the organic materials and mercaptans disposed in the wastewater stream.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a schematic view of a wastewater purification process in accordance with the present disclosure; and

FIG. 2 is a schematic view of a solid treatment process used in conjunction with the wastewater purification process shown in FIG. 1.

### DETAILED DESCRIPTION OF THE DISCLOSURE

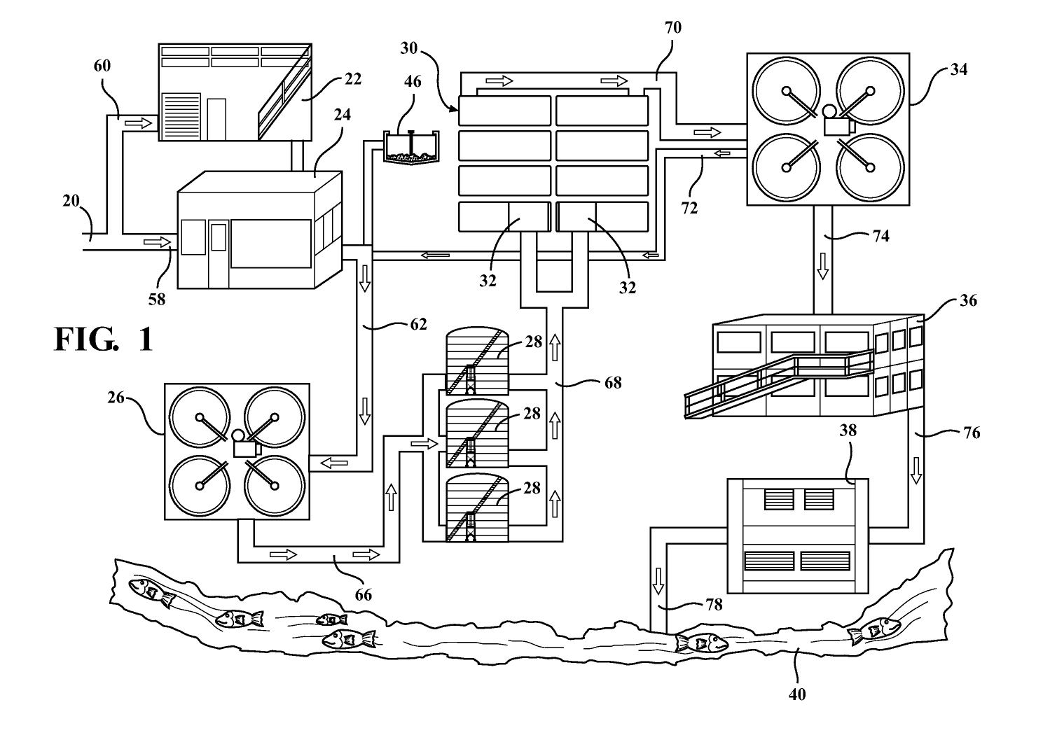

Referring to the Figures, wherein like numerals indicate corresponding parts throughout the several views, a method for improving a wastewater purification process for purifying a wastewater stream 20 containing organic materials, raw sludge, a plurality of mercaptans, grit and grease in accordance with an aspect of the disclosure is shown in FIG. 1. Typically, the wastewater purification process includes using an equalization basin 22 or a plurality of equalization basins 22 for receiving and storing the wastewater stream 20. Initially, the wastewater stream 20 passes to a screen building 24 having a plurality of bar screens to remove the grit and the grease from the wastewater stream 20. According to an aspect, multiple primary clarifiers 26 may be used to allow the raw sludge in the wastewater stream 20 to settle and also skim off the grease from the surface of the wastewater stream 20. Next, a plurality of rough filters 28 may be used to also filter and reduce the amount of the organic materials in the wastewater stream 20. A plurality of aeration tanks 30 each defining an anoxic zone 32 and, including a plurality of microorganism, can be used for denitrificating the wastewater stream 20 to further remove the amount of organic materials in the wastewater stream 20. According to another aspect, secondary clarifiers 34 may be used to allow the microorganisms in the wastewater stream 20 to settle after the denitrication process in the aeration tanks 30. Tertiary sand filters 36 may then be used to filter the wastewater stream 20 after the settling occurs in the secondary clarifiers 34. Ultraviolet (UV) disinfection facilities 38 can be used to provide an ultraviolet radiation to disinfect the wastewater stream 20 after it exits the tertiary sand filters 36. Finally, the disinfected wastewater stream 20 can be discharged to a remote water source 40 such as a creek or a river after completion of the treatment process.

Typically, a solid treatment process is also used in conjunction with the wastewater purification process for treating solids produced throughout the wastewater purification process. According to an aspect, fixed cover vessels 42 and floating cover vessels 44 may be used in the solid treatment process to subject the raw sludge settled in the primary clarifiers 26 to an anaerobic digestion process which decomposes the raw sludge. Gravity thicken vessels 46 may also be used in connection with the secondary clarifiers 34 for allowing the microorganism in the secondary clarifier 34 to settle in the gravity thicken vessel 46. Solid handling facilities 48 having a plurality of sludge tanks 50 can then be used to store and process the sludge obtained throughout the wastewater purification process. Often, the solid handling facilities 48 also include belt presses 52 and a belt thickener 54 for removing water from the sludge and compressing the sludge into sludge cakes 56.

According to an aspect, the method for improving a wastewater purification process in accordance with the present disclosure includes a first step of dividing the wastewater stream 20 into a primary stream 58 and a secondary stream 60. Next, the grit and the grease can be removed from the primary stream 58 by sending the primary stream 58 through the bar screens in the screen building 24. The secondary stream 60 can be stored by transferring the secondary stream 60 to the equalization basin 22. The grit and the grease can also be removed from the secondary stream 60 by sending the secondary stream 60 through the bar screens in the screen building 24. According to an aspect, the primary stream 58 and the secondary stream 60 may be combined in the screen building 24 to produce a mixed stream 62 containing at least organic materials, the raw sludge and the mercaptans.

After producing the mixed stream 62, the grease remaining in the mixed stream 62 may be skimmed off by feeding the mixed stream 62 to the primary clarifier 26. The raw sludge in the mixed stream 62 may be settled in the primary clarifier 26 to produce a primary sludge stream 64 including a majority of the raw sludge and the mercaptans and a primary clarified effluent 66 including a majority of the organic materials. Subsequently, the organic materials in the primary clarified effluent 66 can be reduced by filtering the primary clarified effluent 66 through the rough filters 28 to produce a filtered effluent 68.

Next, according to an aspect, the filtered effluent 68 may be subjected to a denitrification process by feeding the filtered effluent 68 through the aeration tanks 30 and circulating the filtered effluent 68 between the anoxic zone 32 and the microorganisms in the aeration tanks 30 to produce an aeration stream 70 including the microorganisms. After producing the aeration stream 70, the aeration stream 70 may be sent to the secondary clarifier 34 to settle the aeration stream 70 in the secondary clarifier 34 to produce an activated sludge stream 72 containing activated sludge including a majority of the microorganisms and a secondary clarified effluent 74 which includes the microorganisms disposed in suspension in the secondary clarified effluent 74.

According to another aspect, the secondary clarified effluent 74 may be fed through the sand layers of the tertiary sand filters 36 to remove any of the microorganisms disposed in suspension in the secondary clarified effluent 74 to produce a sand filtered effluent 76. Accordingly, the sand filtered effluent 76 can be disinfected by feeding the sand filtered effluent 76 through the UV disinfection facility 38 to subject the sand filtered effluent 76 to the ultraviolet radiation to produce a disinfected effluent 78. Lastly, the disinfected effluent 78 may be discharged to the remote water source 40, e.g. a creek or a river.

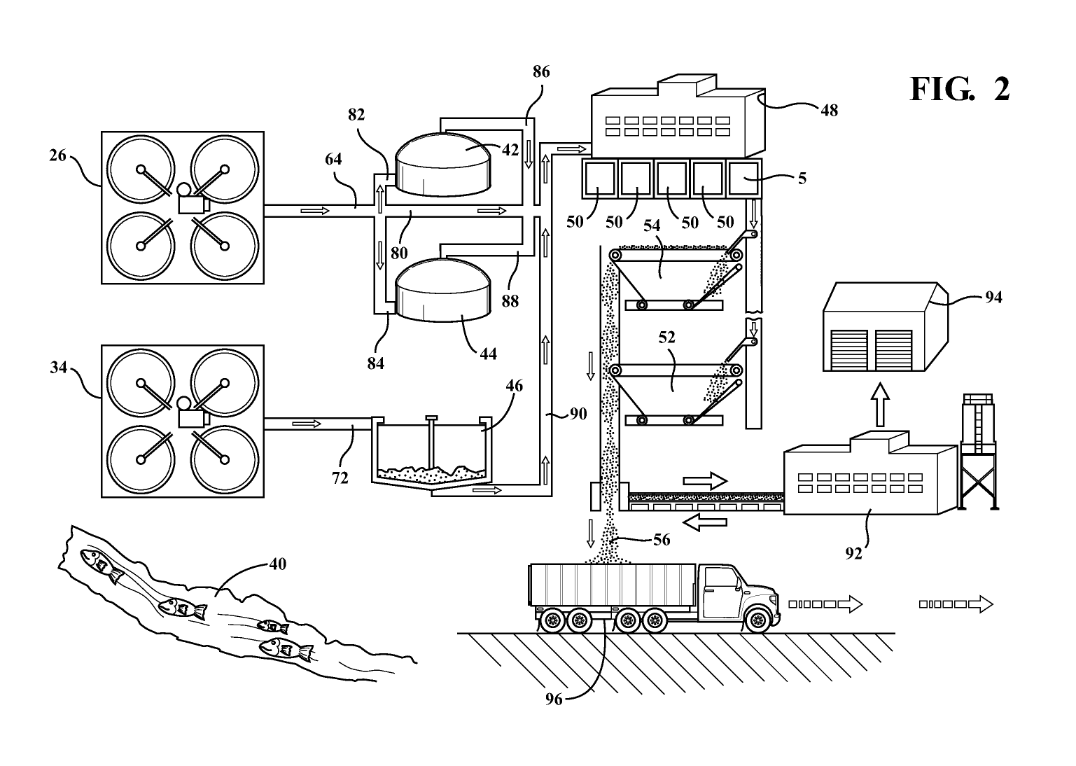

FIG. 2 discloses a method for processing solids produced in the improved wastewater purification process shown in FIG. 1. The method for processing solids may include the first step of removing the primary sludge stream 64 from the primary clarifier 26. The primary sludge stream 64 can be divided into a raw sludge bypass stream 80 and a first digestive stream 82 and a second digestive stream 84.

The raw sludge and the mercaptans in the first digestive stream 82 are decomposed by feeding the first digestive stream 82 to the fixed cover vessel 42 to subject the first digestive stream 82 to an anaerobic digestive process to produce a first layer effluent 86. The raw sludge and the mercaptans in the second digestive stream 84 may also be decomposed by feeding the second digestive stream 84 to the floating cover vessel 44 to subject the second digestive stream 84 to the anaerobic digestive process to produce a second layer effluent 88. Next, the first layer effluent 86 and the second layer effluent 88 can be combined with the raw sludge bypass stream 80 to produce a mixed effluent 80, 82, 84.

According to an aspect, the activated sludge stream 72 including the activated sludge may be removed from the secondary clarifier 34. The activated sludge in the activated sludge stream 72 can be settled by feeding the activated sludge stream 72 to the gravity thicken vessel 46 to produce a settled stream 90 including the activated sludge. After producing the settled stream 90, the settled stream 90 and the mixed effluent 80, 82, 84 may be combined to produce a composite stream 80, 86, 88, 90 including the raw sludge and the activated sludge.

According to another aspect, the raw sludge and the activated sludge in the composite stream 80, 86, 88, 90 may be thickened by injecting polymers into the stream. According to an aspect, the polymers may be injected at a rate of between 150 mg and 200 mg to one Liter of the composite stream 80, 86, 88, 90. Accordingly, the raw sludge and the activated sludge may be stored by feeding the composite stream 80, 86, 88, 90 to the sludge tanks 50 in the solid handling facility 48. Next, the raw sludge and the activated sludge may be compressed by feeding the raw sludge and the activated sludge from the sludge tanks 50 to the belt press 52 and the belt thickener 54 to produce a plurality of sludge cakes 56. The sludge cakes 56 can be treated by subjecting the sludge cakes 56 to a lime stabilization process 92 for reducing odor of the sludge cakes 56 and transferring the sludge cakes 56 to sludge cake storage facilities 94 for storing the plurality of sludge cakes 56. Alternatively, a sludge hauler 96 can be used to transfer the sludge cakes 56 to a landfill for disposal.

According to an aspect, prior to the step of injecting the plurality of polymers, an additive agent may be injected into the wastewater stream to reduce odor produced by the organic materials and the mercaptans. The additive agent may be injected at a distance of 1 to 3,000 feet prior to dividing the wastewater stream 20 and at a rate of at least 1 gallon per 50,000 mg of the organic materials and the raw sludge in the wastewater stream 20. Obviously, the distance for injection may be greater depending upon the circumstances and variables. Alternatively, the additive agent can be injected directly to the composite stream 80, 86, 88, 90 at the rate of at least 1 gallon per 50,000 mg of the organic materials and the raw sludge in the composite stream 80, 86, 88, 90. According to another aspect, the additive agent injected to the wastewater treatment stream may be an Oxidiation/Reduction (REDOX) reagent wherein the REDOX reagent is Copper Sulfate Pentahydrate for treating the organic materials and the plurality of mercaptans in the wastewater treatment stream. In accordance with a further aspect of the disclosure, one exemplary additive agent is Planet Breeze, which is available from D3W Industries of Northville, Mich. Planet Breeze includes the Copper Sulfate Pentahydrate in a liquid form as an active ingredient. Alternatively, other additive reagents with other compositions can be employed, such as Earthtec® from Earth Sciences Laboratories, Inc. The additive agent can also be injected at any place or a combination of places throughout the wastewater purification process, e.g., primary clarifier 26 and secondary clarifier 34. According to an aspect, the amount of additive agent injected is preferably in accordance with EPA guidelines of 1 gallon per 30,000 mg of organic waste. However, the present invention allows for the use of less additive agent and, specifically, in a range of 1 gallon per 40,000 mg of organic waste and even as low as 1 gallon per 50,000 mg of organic waste. This can yield significant chemical savings. It will be appreciated that the additive agent may be injected at different rates, in different quantities and at a variety of different locations.

### EXAMPLE 1

In a first test run, Planet Breeze was used in a wastewater treatment facility in a span of 50 days and the results showed a combined average increase in dry sludge cake solids of approximately 5.4% and an average decrease of 0.22 tons water per dry ton hauled. The results were measured by using a centrifuge and a belt filter press (BFP):

| | Dry Sludge Cake Solids (%) | Dry Sludge Cake Solids |
|---|---|---|
| | without adding Planet Breeze | (%) adding Planet Breeze |
| Centrifuge | 26.7 | 27.9 |
| Belt Filter | 24.2 | 25.7 |
| Press (BFP) | Wet Tons per Dry Tons | Wet Tons per Dry Tons |
| | Hauled (tons) without adding | Hauled (tons) adding Planet |
| | Planet Breeze | Breeze |
| Centrifuge | 3.745 | 3.584 |
| Belt Filter | 4.132 | 3.891 |
| Press (BFP) | | |

### EXAMPLE 2

In a second test run, Planet Breeze was used in a wastewater treatment facility in a span of 4 weeks and the results showed an improvement in dry cake solids and an average decrease (over the span of 15 days) in suspended solids in effluents of approximately 29%:

| | Dry Sludge Cake | Dry Sludge Cake |
|---|---|---|
| | Solids (%) without | Solids (%) adding |
| | adding Planet Breeze | Planet Breeze |
| Dry Solids to Centrifuge by | 25.2 | 27.7 |
| Range (4.0%-5.0%) | | |
| Dry Solids to Centrifuge by | 26.7 | 27.2 |
| Range (5.1%-5.5%) | | |
| Dry Solids to Centrifuge by | 27.1 | 27.8 |
| Range (5.6%-6.0%) | | |
| Dry Solids to Centrifuge by | 27.9 | 29.8 |
| Range (6.1%-6.5%) | | |
| | Suspended Solids | Suspended Solids |
| | in Effluent | in Effluent |
| | (mg/L) without | (mg/L) with |
| | adding Planet | adding Planet |
| | Breeze | Breeze |
| 15 Day Average | 1165 | 827 |

### EXAMPLE 3

In a third test run, Planet Breeze was used in a wastewater treatment facility in a span of 2 weeks (13 days) and the results showed an average increase in dry solids of approximately 18.3%:

| | Dry Sludge Cake Solids (%) | Dry Sludge Cake Solids (%) |
|---|---|---|
| | without adding Planet Breeze | adding Planet Breeze |
| Day 1 | 16.28 | 17.82 |
| Day 2 | 16.53 | 19.34 |
| Day 3 | 16.15 | 18.66 |
| Day 4 | 15.61 | 18.03 |
| Day 5 | 16.69 | 20.81 |
| Day 6 | 19.83 | 19.91 |
| Day 7 | 18.80 | 18.57 |
| Day 8 | 15.40 | 19.02 |
| Day 9 | 14.38 | 20.82 |
| Day 10 | 17.56 | 23.37 |
| Day 11 | 15.64 | 18.03 |
| Day 12 | 15.06 | 20.01 |
| Day 13 | 15.87 | 18.44 |

### EXAMPLE 4

In a fourth test run, Planet Breeze was used in a wastewater treatment facility in a span of 1 week (Monday through Friday) and the results showed an average increase in dry solids of approximately 20.5%:

| | | Dry Sludge |
|---|---|---|
| | Dry Sludge Cake Solids (%) | Cake Solids (%) |
| | without adding Planet Breeze | adding Planet Breeze |
| Monday | 23.0 | 26.4 |
| Tuesday | 23.9 | 25.5 |
| Wednesday | 22.0 | 26.8 |
| Thursday | 22.4 | 28.9 |
| Friday | 23.0 | 30.1 |

It has been discovered that the combination of the polymers and the REDOX reagent together with the timing and location of their injection has provided significant and unexpected improvement in the reduction and control of odor as well as a reduction in amount of liquid remaining in the sludge cakes 56 or an increased percentage of dry solids. Specifically, in accordance with an aspect, the chemical reagent may be injected up-stream from the injection of the polymers directly into the wastewater stream 20. The distance of the additive agent injection can also be affected by the speed of the wastewater stream 20 into which it is injected. It has been discovered that by injecting the additive agent into the water stream prior to injecting the polymers, the additive agent can bind with the polymer before treating the sludge cakes 56. This has the effect of not only helping reduce the amount of liquid in the sludge cake 56, but it assists in significantly reducing the odor. It will also be appreciated that the REDOX reagent (or similar chemical reagent) can also be dripped directly into the gravity thicken vessel 46. Alternatively, it can be added directly into the activated sludge stream 72. It can also be added by separate vehicles or a variety of other suitable ways. It will be understood that the above description is merely exemplary and intended to illustrate the wastewater treatment method of the present disclosure can vary from the exemplary method and structure described above and can include more, less or different steps, structures or configurations than those described above.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

In addition to the average increase in dry solids at the wastewater treatment facility, results obtained from the fourth test run also showed an average decrease of ambient mercaptans (H₂S) of 92.3% in a span of 2 weeks (11 days).

Obviously, many modifications and variations of the present invention are possible in light of the above teachings and may be practiced otherwise than as specifically described while within the scope of the appended claims.

What is claimed is:

1. A method for improving a wastewater purification process comprising purifying a wastewater stream containing organic materials, raw sludge, a plurality of mercaptans, grit and grease and,
thickening the raw sludge in the wastewater stream by injecting polymers,
injecting an additive agent prior to injecting polymers the raw sludge to reduce odor produced by the organic materials and the mercaptans.

2. A method as set forth in claim 1 wherein the step of injecting the additive agent further including injecting the additive agent at a distance of 1 to 3,000 feet prior to purifying the wastewater stream.

3. A method as set forth in claim 2 wherein the step of injecting the additive agent further including injecting the additive agent at a rate of at least 1 gallon to 50,000 mg of the organic materials and the raw sludge in the wastewater stream.

4. A method as set forth in claim 3 wherein the step of injecting the additive agent further including injecting a REDOX reagent.

5. A method as set forth in claim 4 further wherein the step of injecting the REDOX agent further including injecting Copper Sulfate Pentahydrate for treating the organic materials and the plurality of mercaptans in the wastewater treatment stream.

6. A method for improving a wastewater purification process having a screen building including a plurality of bar screens, an equalization basin, a primary clarifier, a plurality of rough filters, a plurality of aeration tanks each defining an anoxic zone and including a plurality of microogranisms, a secondary clarifier, a tertiary sand filter including a plurality of sand layers, an UV disinfection facility for providing an ultraviolet radiation, a remote water source, a fixed cover vessel, a floating cover vessel, a gravity thicken vessel and a solid handling facility having a plurality of sludge tanks and including a belt press and a belt thickener, used for purifying a wastewater stream containing organic materials and raw sludge and a plurality of mercaptans and grit and grease comprising the steps of;
dividing the wastewater stream into a primary stream and a secondary stream,
removing the grit and the grease from the primary stream by sending the primary stream through the bar screens in the screen building,
storing the secondary stream by transferring the secondary stream to the equalization basin,
removing the grit and the grease from the secondary stream by sending the secondary stream through the bar screens in the screen building,
combining the primary stream and the secondary stream in the screen building to produce a mixed stream containing the organic materials and the raw sludge and the mercaptans,
skimming off the grease remaining in the mixed stream by feeding the mixed stream to the primary clarifier,
settling the raw sludge in the mixed stream in the primary clarifier to produce a primary sludge stream including majority of the raw sludge and the mercaptans and a primary clarified effluent including majority of the organic materials,
reducing the organic materials in the primary clarified effluent by filtering the primary clarified effluent through the rough filters to produce a filtered effluent,
denitrificating the filtered effluent by feeding the filtered effluent through the aeration tanks and circulating the filtered effluent between the anoxic zone and the microorganisms in the aeration tanks to produce an aeration stream including the microorganisms,
settling the aeration stream in the secondary clarifier to produce an activated sludge stream containing activated sludge including a majority of the microorganisms and a secondary clarified effluent including the microorganisms disposed in suspension in the secondary clarified effluent,
removing the microorganisms disposed in suspension in the secondary clarified effluent from the secondary clarified effluent by feeding the secondary clarified effluent through the sand layers of the tertiary sand filter to produce a sand filtered effluent,
disinfecting the sand filtered effluent by feeding the sand filtered effluent through the UV disinfection facility to subject the sand filtered effluent to the ultraviolet radiation to produce a disinfected effluent,
discharging the disinfected effluent to the remote water source,
removing the primary sludge stream from the primary clarifier,
dividing the primary sludge stream into a raw sludge bypass stream and a first digestive stream and a second digestive stream,
decomposing the raw sludge and the mercaptans in the first digestive stream by feeding the first digestive stream to the fixed cover vessel to subject the first digestive stream to an anaerobic digestive process to produce a first layer effluent,
decomposing the raw sludge and the mercaptans in the second digestive stream by feeding the second digestive stream to the floating cover vessel to subject the second digestive stream to the anaerobic digestive process to produce a second layer effluent,
combining the first layer effluent and the second layer effluent with the raw sludge bypass stream to produce a mixed effluent,
removing the activated sludge stream including the majority of the microorganism from the secondary clarifier,
settling the activated sludge in the activated sludge stream by feeding the activated sludge stream to the gravity thicken vessel to produce a settled stream including the activated sludge,
combining the mixed effluent with the settled stream to produce a composite stream containing the raw sludge and the activated sludge,
thickening the raw sludge and the activated sludge in the composite stream by injecting polymers at a rate of between 150 mg to 200 mg to Liter of the composite stream to the composite stream,
storing the raw sludge and the activated sludge from the composite stream by feeding the composite stream to the sludge tanks in the solid handling facility,
compressing the raw sludge and the activated sludge together by feeding the raw sludge and the activated sludge to the belt press and the belt thickener to produce a plurality of sludge cakes,
injecting an additive agent prior to injecting the plurality of polymers to reduce odor produced by the organic materials and the mercaptans.

7. A method as set forth in claim 6 wherein the step of injecting the additive agent further including injecting the additive agent at a distance of 1 to 3,000 feet prior to purifying the wastewater stream.

8. A method as set forth in claim 7 wherein the step of injecting the additive agent further including injecting the additive agent at a rate of at least 1 gallon to 50,000 mg of the organic materials and the raw sludge in the wastewater stream.

9. A method as set forth in claim 6 wherein the step of injecting the additive agent further including injecting the additive agent to the composite stream.

10. A method as set forth in claim 6 wherein the step of injecting the additive agent further including injecting a REDOX reagent.

11. A method as set forth in claim 10 further wherein the step of injecting the REDOX agent further including injecting Copper Sulfate Pentahydrate for treating the organic materials and the mercaptans in the wastewater treatment stream.

12. A method as set forth in claim 6 further including the step of subjecting the sludge cakes to a lime stabilization process for reducing odor of the sludge cakes.

13. A method as set forth in claim 12 further including the step of transferring the sludge cakes to a sludge cake storage facility for storing the sludge cakes.

14. A method as set forth in claim 6 further including the step of transferring the sludge cakes to a sludge hauler for disposal at a landfill.
